(19) United States
(12) Patent Application Publication
(10) Pub. No.: US 2012/0248661 A1
(43) Pub. Date: Oct. 4, 2012

(54) HEAVY PLASTIC

(75) Inventor: Ralph Locke, Fort Myers, FL (US)

(73) Assignee: WASBBB, INC., Fort Wayne, IN (US)

(21) Appl. No.: 13/439,246

(22) Filed: Apr. 4, 2012

Related U.S. Application Data
(60) Provisional application No. 61/471,281, filed on Apr. 4, 2011.

(51) Int. Cl. C08L 69/00; B29C 47/00; B29C 49/04; C08F 120/06; B29C 49/00

(52) U.S. Cl. 264/540; 526/221; 525/148; 264/523; 264/176.1

(57) ABSTRACT

A polymeric composition composed of a polymeric material and at least one additive. The polymeric material is at least one of a polymeric precursor material or a melt processible polymeric material. The additive is complexed with the polymeric material and is an inorganic or organo-inorganic complex that is integrated into at least a portion of the polymeric chains in the polymeric composition. The additive may be at least one of oxide glass compounds or halogenated post-transition metal compounds and is present in an amount sufficient to increase the material weight without unduly compromising optical qualities such as transparency to visible light. The polymeric composition can be provided in melt processible form to be used to produce articles such as drinking glasses and the like. The composition can be produced by processes such as dispersion by polymerization of the monomers producing the desired polymeric material in the presence of the additive.

### CROSS-REFERENCE TO RELATED APPLICATION

This application claims the benefit of U.S. provisional patent application serial number 61/471,281 filed on Apr. 4, 2011.

TECHNICAL FIELD

The present invention relates in general to heavy weight polymeric materials. The present invention also relates to optically transparent polymeric material that is durable and highly shatter resistant in its molded state.

### BACKGROUND

Currently, optically clear polymeric materials are generally lighter weight materials. In various applications, there is a need for heavier, denser moldable materials that can be processed into articles such drinking glasses and the like that will mimic the weight, feel and performance of glass but would be more robust and durable.

Thus far, various polycarbonates and co-polyesters have been employed in packaging and as a replacement for glass in glassware and dishes. However these articles tend to be light-weight and lack the desired density and heft of corresponding articles made from glass. Thus it would be desirable to provide a polymeric composition that can be processed into articles including, but not limited to, drinking glasses and the like that will be more robust than articles made from corresponding glass materials but will provide the weight and heft generally associated with corresponding volumes of glass material. It is also desirable to provide articles such as drinking glasses composed of such heavy polymers

### SUMMARY

A polymeric composition composed of a polymeric material and at least one additive. The polymeric material is at least one of a polymeric precurser material, a melt processible polymer or a mixture of the two. The additive is complexed with the polymeric material to impart an inorganic or organo-inorganic compound integrated into at least a portion of polymeric chains in the polymeric material. The additive may be at least one of oxide glass compounds or halogenated post-transition metal compounds. The additive is present in an amount sufficient to increase the material weight without unduly compromising optical qualities such as transparency to visible light.

The polymeric composition can be provided in melt processible form to be used to produce articles such as drinking glasses and the like. The composition can be produced by processes such as dispersion polymerization producing the desired polymeric material in the presence of the additive.

### DETAILED DESCRIPTION

The polymeric composition disclosed herein can be described as a “heavy” plastic or polymer. The materials disclosed herein are melt processible and process characteristics of optical transparency that approach or mimic those of silica glass. The materials disclosed herein resist shatter, chipping and breakage. They are typically more durable than their glass counterparts and can be formed into various shapes and contours, including, but not limited to, drinking glasses and the like. In end use food delivery applications, the polymeric composition will be suitable for use with food (i.e. generally recognized as safe or GRAS) and can be classified as dishwasher safe.

The polymeric composition and articles containing the same can be a “heavy” plastic that possesses optical qualities similar to glass. The polymeric material will be clear or essentially clear with an index of refraction in the range conventionally occupied by glass. The material will have an optical transparency to visible light greater than 85%.

As used herein, the term “heavy”, as in heavy plastic, is taken to mean polymeric compositions having a density and/or a molecular weight that is at least 5% greater than a corresponding polymeric materials that have been complexed or polymerized without the additive. In many applications, the increase in density and/or weight can be as much as 15% or more over the corresponding polymeric composition. It is contemplated that the polymeric composition, when molded into a suitable article such as a drinking glass, can have a density that is closer to materials such as soda lime glass or silica glass and has a density in a range generally greater than about 1.2 and is equal to or less than that of soda lime glass (approximately 2.2 to 2.5 g/cm³ at 20° C).

The polymeric composition disclosed herein includes a polymeric material that preferably will process an optical transparency for visible light of 75% or greater when the material is melt processed. In certain embodiments, the polymeric material can include at least one of acrylates, polycarbonates, or copolyesters.

The term “polymeric material” as defined herein can also include polymeric precursors of the same. In such applications, it is contemplated that the polymeric precursors can be present in a prepolymerized state associated with suitable additives in order to permit the desired polymerization reaction and incorporation of the additive into the polymeric matrix during the polymerization reactions with the end result being a polymeric composition with the additive included therein.

The additive employed in the polymeric composition is at least one of oxide glass components or halogenated post-transition metal compounds or mixtures thereof. The term “oxide glass components” as used herein is broadly construed to mean inorganic oxides employed in production of soda lime glass. The term “halogenated post-transition metal compounds” is broadly construed as select elements from Group IIIA, Group IVA and Group VA halogenated with a suitable compound from Group VIIA.

It has been found, quite unexpectedly, that this class of material i.e. oxide glass components and halogenated post-transition metal compounds can be integrated into various polymeric materials to increase the weight and density of the associated polymeric compound. Without being bound to any theory it is believed that oxide glass components and halogenated post-transition metal compounds, when present in matrix with the polymerizing monomers, complex with the existing and developing polymeric chains in a manner that increases the density and/or weight of the resulting polymeric material without unduly compromising physical properties including, but not limited to, melt processibilty and/or transparency as well as other optical qualities. The resulting composition can be melt processed alone or and melt processed with additional polymeric feed stock.

The resulting polymeric composition can be melt processed directly. Alternately it is contemplated that the polymeric composition can be integrated into other polymeric feedstock to impart the desired qualities.

The oxide glass component can be one or more compounds from the following group: aluminum oxide, antimony trioxide, arsenic trioxide, barium oxide, bismuth (III) oxide, boron trioxide, calcium oxide, cerium (III) oxide, chromium (III) oxide, iron (III) oxide, lanthanum (III) oxide, lead (II) oxide, lithium oxide, magnesium oxide, phosphorus pentoxide, potassium oxide, silicon dioxide, sodium oxide, strontium oxide, sulfur dioxide, tin dioxide, titanium dioxide, zinc oxide, zirconium oxide as well as mixtures of one or more of the foregoing. In specific embodiments, the oxide glass component can be bismuth oxide such as bismuth (III) oxide that can be added during the polymerization process.

Suitable post transition metals include aluminum, gallium, indium, thalium, tin, lead, and bismuth. The compounds can be suitably halogenated by any suitable halogen; particularly with halogens such as fluorine, chlorine or bromine. It is contemplated that the additive component can be a mixture of suitable compounds if desired or required. In various embodiments, the additive component can be bismuth oxide, bismuth chloride and combinations thereof.

The polymeric material as broadly construed can be any suitable polymeric compound having the desired qualities of transparency, refractive index etc. Various thermosetting polymers can be successfully employed in certain embodiments of the composition disclosed herein. Materials such as polyacrylates, polycarbonates and copolyesters are particularly efficacious in certain applications. It is also within the purview of this disclosure to employ certain optically clear cellulosic polymers in combination with or instead of the aforementioned materials.

Suitable copolyesters can be obtained by, for example, a polycondensation of a dicarboxylic acid component and a diol component, a polycondensation of a hydroxycarboxylic acid or a lactone, or a polycondensation of these components. The preferred polyester-series resin usually includes a saturated polyester-series resin, in particular an aromatic saturated polyester-series resin.

Non limiting examples of suitable copolyesters include materials such as those marketed by Eastman Chemical under the tradename Eastar such as Copolyester 6763 and various copolyesters such as those marketed under the tradename Tritan. Suitable materials will be those that have properties that render them amenable to processing by operations including but not limited to extrusion blow molding, injection molding, injection blow molding and the like; particularly those processing applications acceptable in consumer food/ beverage applications. Non-limiting examples of other copolyester materials available from Eastmam include materials designated AN001, GN071, GN077, GN046, GN078, EN076 and EB062. Such materials possess a notched Izod toughness (as determined by ASTM D256) demonstrating no break at between about 50 and 450 J/m, with material as such as EB062 exhibiting greater Izod numbers. Materials of choice will be those suitable for medium to thick wall applications as would be known to those skilled in the art.

Other suitable co-polyesters are produced and marketed by Eastman under the trade mane Tritan. One non-limiting example of a suitable copolyester is Tritan MX711. Materials such as Tritan EX401 are an amorphous copolyester with excellent appearance and clarity. Tritan EX401 is believed to contain a mold release derived from vegetable based sources. Its most outstanding features are excellent toughness, hydrolytic stability, and heat and chemical resistance. Materials such as Tritan FX100 and FX 200 are believed to be amorphous copolyesters that combine excellent clarity and toughness with outstanding heat and chemical resistance. Other materials include Tritan LX 100 and LX101.

Non limiting examples of cellulosic polymers include those commercially available under the tradename Tenite. It is believed that the Tenite materials are cellulose based products commercially available from Eastman that can be employed as the polymeric component in the present composition. Without being bound to any theory, it is believed that various cellulose acetates, cellulose puterylates and/or various cellulose propianoates can be used in whole or in part to provide the polymeric component as disclosed herein. Non limiting examples of such materials include Eastman products marketed under the name Tenite 105E-26, 485E-08 and 360-E10.

Suitable polycarbonate materials can be formulated by any method including but not limited to processes such as the transesterification of bisphenyl A and diphenyl carbonate or a bisphenyl A reaction involving phosgene. Polycarbonate employed can have any suitable structure such as:

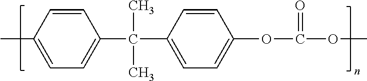

The polycarbonate material employed herein is a tough, dimensionally stable, transparent thermoplastic that has many applications which demand high performance properties. The thermoplastic is believed to maintain its properties over a wide range of temperatures, from 40″F to 280° F. It is available in three types: machine grade; window and glass-filled. It is the highest impact of any Thermoplastic, transparent up to 2″ in special grades, outstanding dimensional and thermal stability, exceptional machinability, stain resistant and non-toxic with low water absorption. The polymer employed can be of glass quality that is provide an material that is optically clear, provide luminous transmittance and low haze factor.

Polycarbonate material employed can have suitable physical properties. Poly-carbonates with a density between 1.2 and 1.22 g/cm³ and a refractive index between 1.584 and 1.586 can be employed. Non-limiting examples of suitable mechanical properties include tensile strength 55-75 MPa elongation at break 80-150%, Rockwell hardness value of M70; Izod impact strength 600-850J/m; and a Charpy notch test value of 20-35 kJ/m²; Suitable materials can have a melt temperature of approximately 267 C and a glass transition temperature of approximately 150 C. Suitable polycarbonate material is commercially available under tradenames such as Lexan, Makrolon and Zelux.

Suitable polyacrylates include, but are not necessarily limited to, various methacrylates such as polymethylmethacrylate. Polymethylmethacrylate can also be employed as the polymeric material. Suitable materials are vinyl polymers made by free radical vinyl polymerization from monomeric methyl methacrylate. As used herein, polymethylmethacylate is a synthetic polymer of methyl acrylate and has the formula

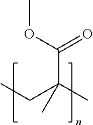

The polymer is of variable molecular mass, has a density of 1.18g/cm³; a melting point of 160 C and a refractive index of 1.4914 at 587.6 nm.

The additive material can be prepared by any suitable method. One non-limiting example of such as process includes the (addition?) polymerization of at least one monomeric precursor such as methacrylic acid in the presence of an additive selected from the group consisting of oxide glass components, halogenated post-transition metal compounds or mixtures of oxide glass components and halogenated post-transition metal compounds under conditions whereby the additive is complexed with the resulting polymer. The additive can be introduced in any suitable form to facilitate integration during polymerization. Where desired or required, the, additive can be present as particulate material such as nanoparticulate material have an average particle size between about 5nm and about 100nm.

The resulting polymeric material with additive complexed therein can be used in various end use processes such as blow molding, extrusion molding and/or extrusion blow molding operations. As such, the material can be processed through blow molding devices, extrusion molding devices and/or extrusion blow molding devices. The resulting polymeric material can also be integrated into other polymeric materials to produce a optically clear polymeric material having a density and/or weight greater than the corresponding base material. The optical transparency of the resulting material will be at least 75% of the corresponding base material with optical transparencies of at least 80% or 85% in many applications. Typical loading of the additive selected form the group consisting of oxide glass components halogenated post-transition metal compounds and mixtures thereof will be between 12% and 22% in the finished processed polymer.

To further illustrate the invention disclosed herein the following non-limiting examples are presented. It is to be understood that the present examples are presented for illustrative purposes and are not construed as limitative of the scope of the appended claims.

### EXAMPLE I

A polymeric additive is prepared by introducing 18 grams of nanoparticluate bismuth oxide having an average particle size between 5 nm and 100 nm into 82 grams of polymerizing methacrylic acid. Addition occurring with mixing. Polymerization occurs at a standard temperature and pressure with periodic sampling to determine the extent of polymerization. Approximate polymerization period is between 4 and 5 hours and can be accelerated with the application of heat if desired or required. Final density of the polymeric material is between 1.7 and 1.8. This is taken as evidence of significant to complete saturation of the polyermic chains with bismuth. The resulting material is pelletized. The resulting material is a translucent-to-opaque, shelf stable material having a white natural hue.

### EXAMPLE II

The polymeric additive of Example I is introduced to a reaction mixture of bisphenyl A and diphenyl carbonate undergoing a transesterification reaction to produce polycarbonate in order to provide a ratio of 22 grams additive to 78 grams polycarbonate. Polymerization completion is determined by bisphenyl A depletion. A control sample of polycarbonate is prepared under identical conditions without introduction of the polymeric additive. The resulting material is a shelf stable generally transparent polymeric material. Optical clarity of the resulting material is compared against that of the control material and is found to have a value of 75% or greater of that of the control material. The density of the resulting polymeric material is measured and is found to be approximately 1.5 to 1.0.

### EXAMPLE III

The additive material of Example I is added to a melt mixture of polycarbonate material having an initial density between 1.2 and 1.22 g/cm³ and an initial refractive index between about 1.584 and 1.586. Optical clarity of the resulting material is compared against that of control material and is found to have a value of 75% or greater of that of the control material. The resulting polymeric material is measured and is found to have density between about 1.45 and 1.6.

The invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A polymeric composition comprising:
a polymeric component composed of at least one of a polymeric precurser material, a melt processible polymeric material, or mixtures of a polymeric precursor material and melt processible polymeric material wherein the at least one material produces a polymeric composition having an optical transparency of at least 80%; and
at least one additive selected from the group consisting of oxide glass components, halogenated post-transition metal compounds, and mixtures thereof, wherein the additive is complexed within the polymeric material and increases the weight of the resulting polymeric complex.

2. The polymeric composition of claim 1 wherein the melt processible polymeric material includes at least one of copolyesters, polyacrylates, or polycarbonates.

3. The polymeric composition of claim 1 wherein the oxide glass component is selected from the group consisting of aluminum oxide, antimony trioxide, arsenic trioxide, barium oxide, bismuth oxide, boron trioxide, calcium oxide, cerium oxide, chromium oxide, iron oxide, lanthanum oxide, lead oxide, lithium oxide, magnesium oxide, phosphorus pentoxide, potassium oxide, silicon dioxide, sodium oxide, strontium oxide, sulfur dioxide, tin dioxide, titanium dioxide, zinc oxide, zirconium oxide and mixtures thereof.

4. The polymeric composition of claim 1 wherein the halogenated post-transition metal compound is composed of a post-transition metal selected from the group consisting of aluminum, gallium, indium, thalium, tin , lead, bismuth and mixtures thereof.

5. The polymeric composition of claim 4 wherein the halogen component of the halogenated post-transition metal compound is selected from the group consisting of fluorine, chlorine, bromine and mixtures thereof.

6. The polymeric composition of claim 3 wherein the additive is selected from the group consisting of bismuth oxide, lead oxide, bismuth chloride and mixtures thereof.

7. The polymeric composition of claim 1 wherein the melt processible polymeric material is selected from the group consisting of acrylate polymers, polycarbonate polymers, copolyesters and mixtures thereof.

8. The polymeric composition of claim 7 wherein the oxide glass component is selected from the group consisting of aluminum oxide, antimony trioxide, arsenic trioxide, barium oxide, bismuth oxide, boron trioxide, calcium oxide, cerium oxide, chromium oxide, iron oxide, lanthanum oxide, lead oxide, lithium oxide, magnesium oxide, phosphorus pentoxide, potassium oxide, silicon dioxide, sodium oxide, strontium oxide, sulfur dioxide, tin dioxide, titanium dioxide, zinc oxide, zirconium oxide and mixtures thereof.

9. The polyermic composition of claim 8 wherein the additive is selected from the group consisting of bismuth oxide, lead oxide, bismuth chloride and mixtures thereof.

10. A polymeric composition comprising;
a polymeric component composed of a melt processible polymeric material, wherein the polymeric material includes at least one of copolyesters, polyacrylates, polycarbonates, polyester-polyacrylates, polyester-polycarbonates or polyacrylate-polycarbonates; and
at least one additive selected from the group consisting of oxide glass components, halogenated post-transition metal compounds, and mixtures thereof wherein the additive is complexed within the melt processible polymeric material and increases the weight of the resulting polymeric composition;
wherein the polymeric material and the additive are present in proportion al relationship sufficient to provide optical transparency greater than 85% in the resulting polymeric composition.

11. The polymeric composition of claim 10 wherein the oxide glass component is selected from the group consisting of aluminum oxide, antimony trioxide, arsenic trioxide, barium oxide, bismuth oxide, boron trioxide, calcium oxide, cerium oxide, chromium oxide, iron oxide, lanthanum oxide, lead oxide, lithium oxide, magnesium oxide, phosphorus pentoxide, potassium oxide, silicon dioxide, sodium oxide, strontium oxide, sulfur dioxide, tin dioxide, titanium dioxide, zinc oxide, zirconium oxide and mixtures thereof.

12. The polymeric composition of claim 11 wherein the halogenated post-transition metal compound is composed of a post-transition metal selected from the group consisting of aluminum, gallium, indium, thalium, tin , lead, bismuth and mixtures thereof.

13. The polymeric composition of claim 11 wherein the additive is selected from the group consisting of bismuth oxide, lead oxide, bismuth chloride and mixtures thereof.

14. A process for producing an article composed of a heavy polymer comprising the step of;
polymerizing at least one monomeric precursor in the presence of an additive selected from the group consisting of oxide glass components, halogenated post-transition metal compounds or mixtures of oxide glass components and halogenated post-transition metal compounds under conditions whereby the additive is complexed with the resulting polymer.

15. The process of claim 14 further comprising the steps of;
melt processing the resulting polymer in one of blow molding device, a extrusion molding device or an extrusion blow molding device.

16. A melt processible polymeric material produced by the process of claim 14.
